(19) United States
(12) Patent Application Publication
(10) Pub. No.: US 2004/0006627 A1
(43) Pub. Date: Jan. 8, 2004

(54) Content delivery system

(76) Inventors: Eran Sarfaty, Woodmere, NY (US); Tal Riginiano, Givataim (IL)

Correspondence Address: Supervisor, Patent Prosecution Services, PIPER RUDNICK LLP, 1200 Nineteenth Street, N.W., Washington, DC, 20036-2412, US

(21) Appl. No.: 10/436,201

(22) Filed: May 13, 2003

Related U.S. Application Data
(60) Provisional application No. 60/379,392, filed on May 13, 2002.

(51) Int. Cl. G06F 15/16

(52) U.S. Cl. 709/228

(57) ABSTRACT

A system and method of dynamically broadcasting content, comprising: connecting a provider and a client to a server with a preset server configuration; obtaining provider run time configuration and client run time configuration; and broadcasting the content from the provider to the client, where the preset server configuration, the provider run time configuration, and the client run time configuration are used to connect the a provider and the client to the server without manually entering configuration information. Provider profile information necessary to optimize the provider upload rate is obtained. In addition, messages between providers, clients, and administrators can be sent. Messages from the provider to a second server can also be sent. Billing information specific to the client can also be maintained.

This application claims priority from U.S. Provisional Application Serial No. 60/379,392 filed May 13, 2002. The entirety of that provisional application is incorporated herein by reference.

### BACKGROUND OF THE INVENTION

### Field of the Invention

The present invention relates generally to a streaming system, and particularly to a dynamic streaming system.

### BRIEF DESCRIPTION OF THE FIGURES

FIG. 1 is an overview diagram illustrating an example of video streaming, according to an embodiment of the present invention.

FIG. 2 is an overview diagram illustrating the dynamic video streaming (DVS) system, according to an embodiment of the present invention.

FIG. 3 is a diagram illustrating additional features of the components of FIG. 2, according to an embodiment of the present invention.

FIG. 4 is a flow diagram illustrating a streaming method overview, according to an embodiment of the present invention.

FIGS. 5-13 are flow diagrams illustrating details of the streaming method of FIG. 4, in accordance with one embodiment of the present invention.

FIGS. 14-21 are screen shots illustrating graphical user interface screen, in accordance with one embodiment of the present invention.

### DESCRIPTION OF THE INVENTION

Streaming

Streaming is the ability to view data without first downloading an entire file. In streaming, the play data rate must be lower than the connection data rate. Streaming is particularly useful for real-time data (e.g., news, sporting events) and pay-per-minute events because there is no way that the client can (or should) download the content before watching it. Streaming is also useful for static data (e.g., pre-recorded programs), because it is useful for a client to view the data as he is downloading it. Streaming requires high bandwidth and the ability to transfer and process data to a client. Buffering and encoding assist in streaming. Buffering fills a memory block with data before the data is actually played. Encoding compresses data before it is delivered. Examples of encoding formats for streaming video are: H.261, H.263, MJPEG, MPEG1, MPEG2 and MPEG4. After the data is encoded, it is stored in a buffer, where it is decoded (i.e., decompressed). The usage of encoding reduces volume and network traffic required by network streaming, and thus reduces bandwidth requirements.

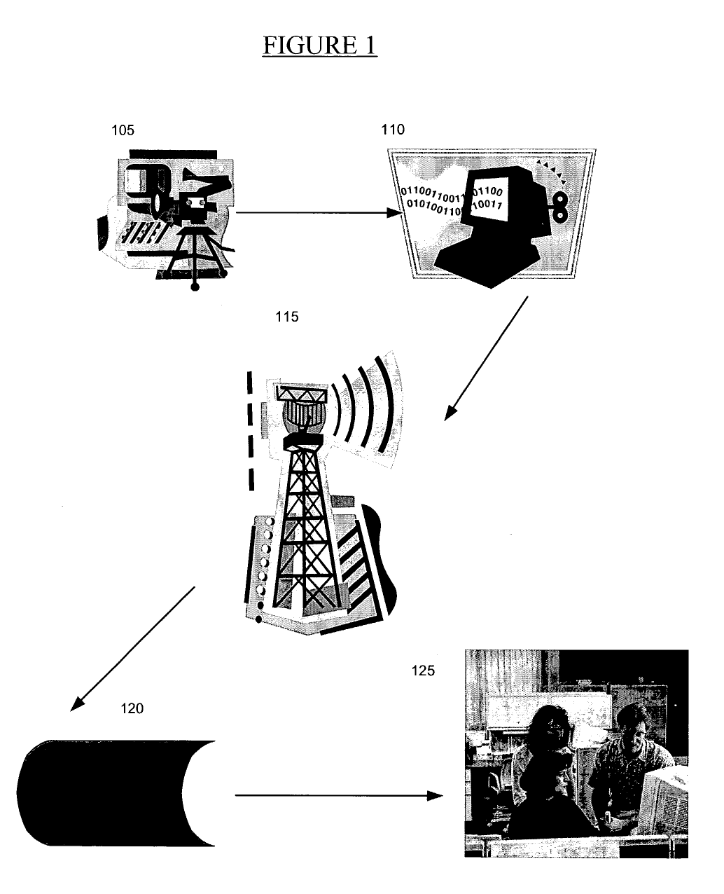

FIG. 1 is an overview diagram illustrating an example of video streaming, according to an embodiment of the present invention. In 105, a data source (e.g., a movie) is broadcast. In 110, the data is encoded. In 115, the encoded data is sent to a DVS server. In 120, the encoded data is buffered. In 120, the data is decoded and presented to clients.

The present invention comprises a system and method of dynamically broadcasting content, comprising: connecting a provider and a client to a DVS server with a preset server configuration; obtaining provider run time configuration and client run time configuration; and broadcasting the content from the provider to the client, where the preset server configuration, the provider run time configuration, and the client run time configuration are used to connect the a provider and the client to the DVS server without manually entering configuration information. A system administrator only needs to install the present invention on a DVS server and a provider. The client requires only a media platform (e.g., Windows media platform Win98 or Win95).

In another embodiment, the present invention enables bandwidth to be used in an advantageous manner, by utilizing profiling mechanisms.

In a further embodiment, the present invention enables clients, administrators, and providers to send messages to each other. Messages may also be sent to other non-DVS servers.

In an additional embodiment, billing and charging information can be detailed to specific clients.

In a further embodiment, dynamic multi-angle viewing, audio and video delay matching, and chatting features can be utilized.

DVS Server, Provider, and Client Components

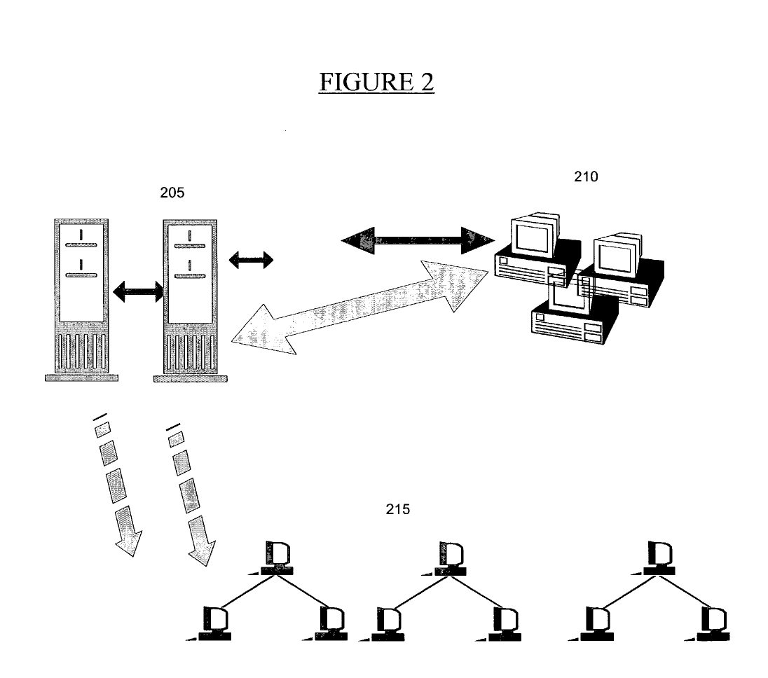

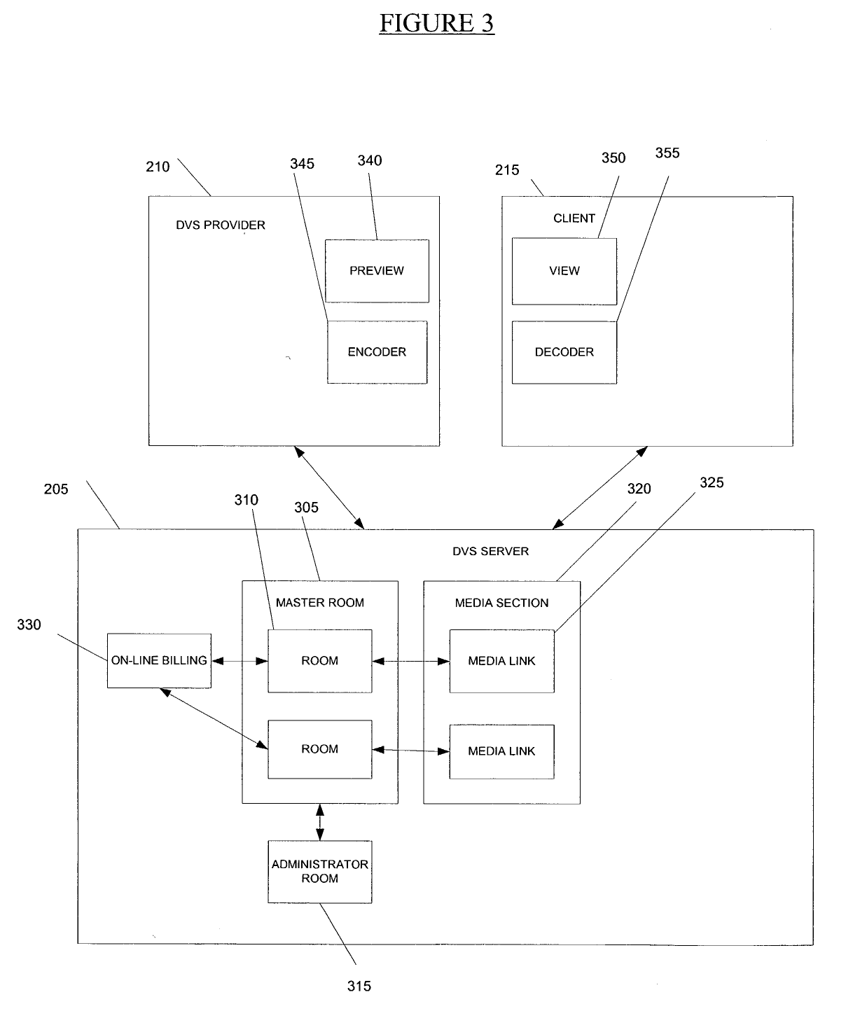

FIG. 2 is an overview diagram illustrating the dynamic video streaming (DVS) system, according to an embodiment of the present invention. The DVS system includes at least one DVS server 205, at least one provider 210, and at least one client 215. FIG. 3 is a diagram illustrating additional features of these components, according to an embodiment of the present invention.

DVS Server. The DVS server 205 monitors and manages the client and the providers' connections. The DVS server includes a master room 305 comprising rooms 310, and an administrator room 315. The master room, room, and administrator room concept is described in detail below. The DVS server also includes a media section 320, and an on-line billing component 330. The media section includes media links 325 that connect to the rooms. The on-line billing component can be tied to the individual rooms.

The DVS server is installed on a media server (e.g., a Microsoft Windows server). A DVS encoder 330 is installed on the media encoder (e.g., a Microsoft Windows Media Encoder). The encoder compresses the data so that it can be transmitted with less bandwidth. The DVS server fully supports database connections for user verification and web modules to make publishing of the content easier.

The DVS server is responsible for creating the provider's connection and rooms, managing the client connection (e.g., the Windows media service), setting profiles on the remote provider application, keeping client logs, managing data streams from dynamic locations, managing publishing and balancing of those locations, managing bandwidth policy for both clients and providers, maintaining the provider's traffic, and notifying clients about new providers (if required). In one embodiment, the DVS server contains a built-in billing system that is ready to connect with any system that uses per-minute billing. (Note that per-event billing does not require an inside billing system.)

Provider. The provider 210 includes a preview feature 340 and a DVS encoder 345. The preview feature formats a document and displays it on a video monitor. The DVS encoder compresses the data so that it can be transmitted with less bandwidth.

The provider connects to the DVS server, and is verified, if required, and then interrogated for bandwidth, IP address, and port information. The DVS server then sets the provider configuration, based upon the best conditions that can be achieved, and also based on the client bandwidth expectancy (e.g., high or low). The provider doesn't need to know anything about these parameters. In fact these parameters will likely change every time the connection is on. The provider then begins the broadcast, which he can stop at anytime, without causing an error on the DVS side, or without billing the customer one second further. In fact, even if the provider crashes (e.g., from power failure or from human error) the DVS server will still balance the outgoing data and disconnect the right connections. Another feature of the DVS system is the ability to change the feed as the customer changes, or even to change the feed while the customer is watching. This is utilized by supplying different content for any provider. The provider can change this content any time, using the DVS upload services. The DVS system allows interaction between the provider of the content and the customer (via chat) without any changes to the DVS server. Another unique feature is the ability for special billing requests to be performed within the session.

The provider is built on top of a media encoder (e.g., a Windows media encoder). Unlike an encoder application that serves a video feed and waits for a connection, the provider is responsible for creating a connection, and starting the dynamic video streaming.

The media encoder is a video utility that enables broadcasting and encoding of live and pre-recorded videos. The media encoder also enables selection of a profile that suits a specific bandwidth.

The provider searches for profiles. Profiles are encoder sets of video and audio encoding, as well as file size and picture motion (FPS—frames per second). If the provider does not find all of the necessary profiles defined by the system setting, it has several ways of responding. An error may result, an attempt to download the profile from a remote location may result, or an attempt to produce the profile on the spot may result. In addition, a default profile may be used. As profiles are critical, a default profile is only used if it is a core profile, and if it has been defined as necessary on the system.

Clients. The client application includes a view 350, and a decoder 355. The view allows the client to view the broadcast. The decoder allows the client application to decompress the data.

The clients 215 receive the feeds from the media server, upon data received from the DVS server. The feeds can be altered or stopped at any time. The client can be embedded into an application support (e.g., Internet Explorer). The client revolves around the room concept. Rooms are the view unit that includes one provider, and multiple clients. The provider may have video and chat capability, and other graphic aids. The client connections are fully managed by the DVS server, and not by the provider application.

Rooms, Master Room, Administrator Room

Rooms. Rooms are objects that hold all the connections that relate in one well-organized structure. The room contains searching, adding, removing and client handling functions. The room is a container type, which holds client connections. The key in the room is the nickname (not the username). The DVS server does not allow multiple logins with the same username into the system, but does allows multiple logins with the same nickname for different rooms. Thus, the username is searched for existence within all the opened rooms upon connection approval. Then, a check is performed to ensure that the user with the nickname does not already exist in the requested room. If such a user does exist, the connection is terminated by the room object. If the client passes all the necessary checks, the client is allowed into the room. The room contains methods for sending text messages within the room, video coordinating between the provider and the clients that reside inside the room, and client deletion and addition functions.

Master Room. The master room object is very similar to the room object. It contains the same strong indexing and filtering ancestor, and does not allow more than one room with the same name. The master room also contains the same multithreaded addition and subtraction functions as the room. However, one difference is that the master room is initialized with the start up of the DVS server statically (e.g., there is only one master room, but an unknown number of rooms).

Room and Master Room Initialization. The master room is initialized as the DVS server starts. Rooms are initialized as the master room creates them as a result of a provider's request. The master room inserts the new requested room into its private container after a successful creation. If any problems were accrued during the creation of the room (e.g., insufficient memory, performance problems, room name in use) the connection with the provider is terminated.

Administrator Room. One room does not exist within the master room: the administrator room. This administrator room is initialized during the DVS server setup, and it is not created dynamically during the setup of the DVS server. The administrator room object is not created in response to a provider request. In fact, there is no provider for this room. The administrator room is for monitoring only. Any administrator that logs into the DVS server can be logged into the administrator room. For maximum speed, the administrator room is always initialized, and does not wait for a first request. The administrator room has its own database connection to ensure maximum speed in database queries for administrators that are logging in. The administrator room is kept separate so that the administrator's connections are not influenced by the provider's behaviour. The administrator room has the following additional capabilities: an independent database connection; a low limit connection number; thread boosting in the case of time critical definitions; and high security in messages.

Dynamic Streaming Method Overview

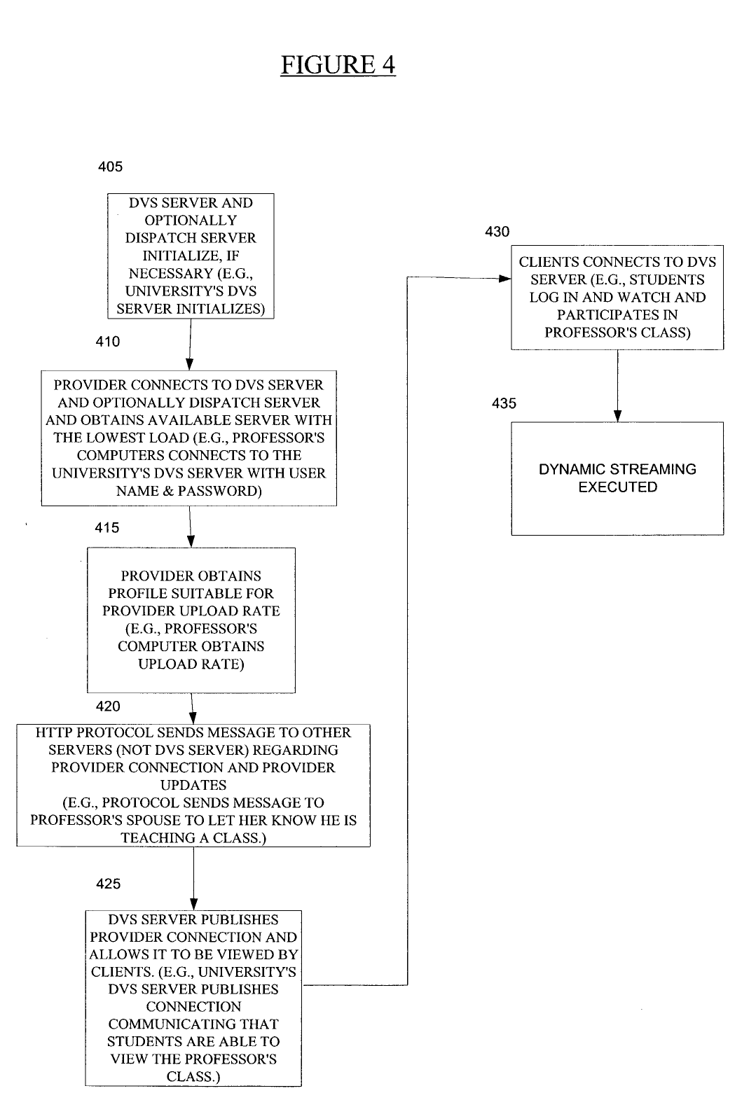

FIG. 4 is a flow diagram illustrating a streaming method overview, according to an embodiment of the present invention.

FIG. 4 discusses an optional embodiment of the present invention, a dispatch server. The dispatch server is a mechanism responsible for load balancing the DVS system. Load balancing is a technique in which two or more servers share a load between them. If a DVS server is configured to use dispatching services, it will, upon initializing, register itself on the dispatch server it was set to. The server will unregister itself shutting down. The dispatch server will unregister a DVS server automatically if it fails to answer a query in a timely fashion. The DVS server then waits for requests from the dispatch services. The only request that the DVS server can receive from the dispatch services is a load request (i.e., how many rooms are opened and how many clients are connected).

Dispatching also has a role with the provider. If configured to use a dispatch server, the provider will contact the dispatch services asking for a server. The dispatch services will then route through the registered servers, requesting them for information. After receiving the requested information, the dispatcher will return the most low-loaded server. The load calculation is done as follows: each client connection is one point; a provider connection is two points; and an administrator connection is three points. The DVS server that has the lowest number of points will be the one chosen to be the dispatch server to be returned to the provider. After retrieving the server address, the provider will complete the regular chores. When clients browse a provider room, the balanced DVS address is already part of the information provided. The dispatch server is an optional piece of 405 and 410, as discussed below.

In 405, the DVS server, and optionally the dispatch server, initialize, if necessary. In the example of a professor (provider) showing a live class to students (clients), the university DVS server would initialize, if necessary.

In 410, the provider, and optionally the dispatch server, connect to the DVS server. For example, the professor's computer taping the class connects to the university's DVS server with a user name and password.

In 415, the provider obtains a profile suitable for the provider's upload rate. For example, the professor's computer obtains the upload rate.

In 420, hypertext transfer protocol (HTTP) sends a message to other servers (not DVS servers) regarding the provider connection and provider updates. For example, an automatic message is sent to the professor's spouse to let her know he is busy teaching a class.

In 425, the DVS server publishes the provider connection and allows it to be viewed by the clients. For example, the university's DVS server publishes the connection communicating that students are able to view the professor's class.

In 430, clients connect to the DVS server and are able to view the content. For example, students log in a watch and participate in the professor's live class.

In 435, the dynamic streaming process is executed.

DVS Server Initialization Process

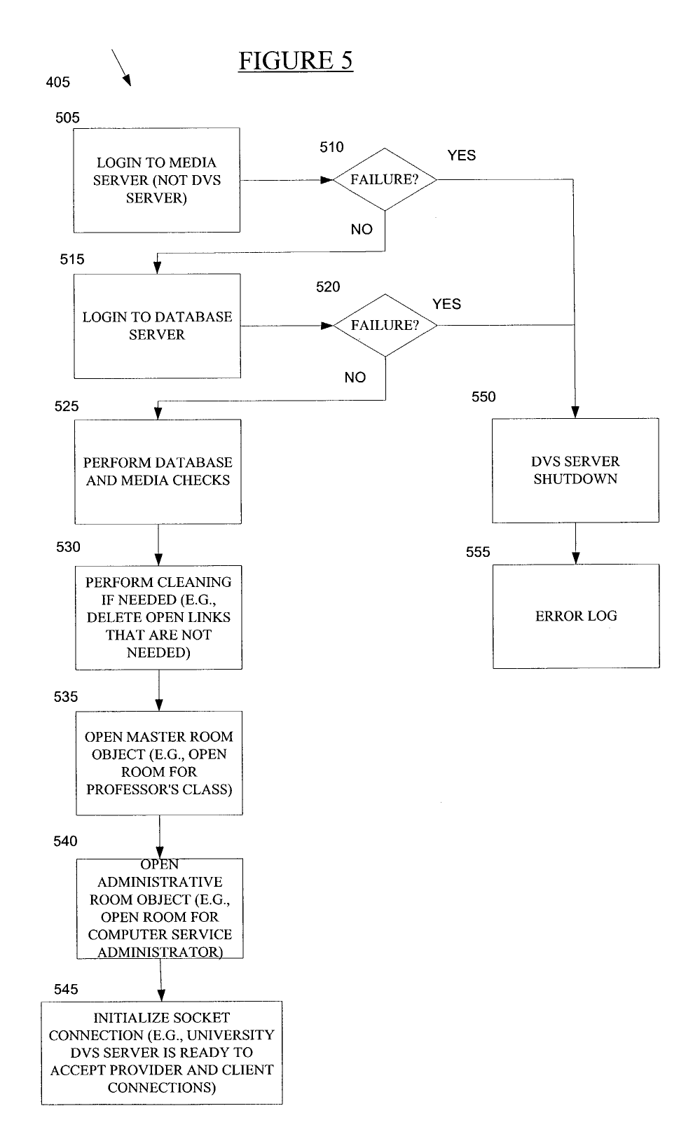

FIG. 5 is a flow diagram illustrating DVS server initialization process 405, according to an embodiment of the present invention. In this process, the DVS server configuration settings are utilized. A database connection is established and a media services (e.g., Windows media service) is present.

In 505, the DVS server logs in to the media server (not a DVS server). In 510, the DVS server opens its database connection and checks to ensure that the connection is valid (e.g., that database transactions are allowed). In 525, the DVS server performs database and media checks, checking the current settings of the media services. In 540, the DVS server performs, if required, cleaning operations on both the DVS server and the media server. The cleaning operations, for example, remove any previous failed links or records as a result of a system failure. In 535, the DVS server opens the master room. In 540, the DVS server opens an administrative room. In 545, the socket connection initialization is performed, and the DVS server opens its listening connection for the clients (e.g., the university DVS server listens for provider and client connections).

In 510 and 520, in any case of an initialization error, the service will shut down in 550, as there is no point continuing the service if the initialization process failed.

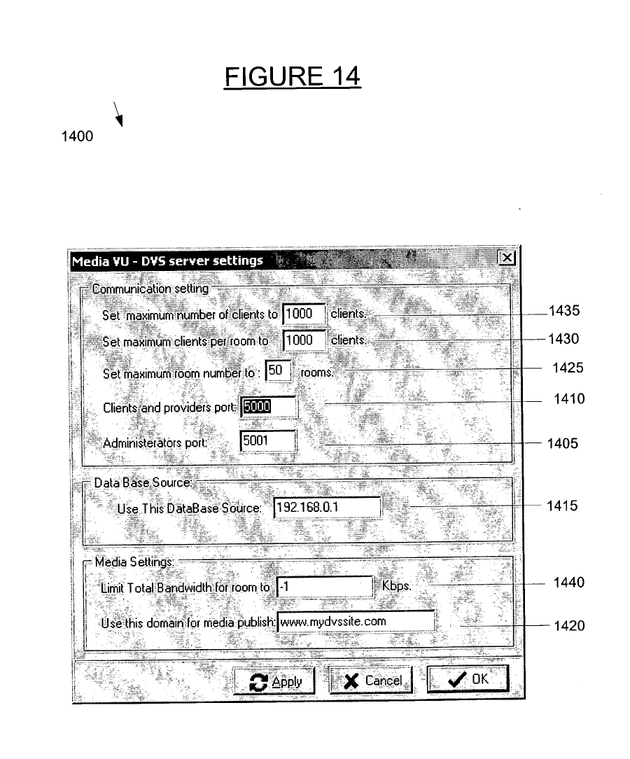

FIG. 14 is a screen shot illustrating the DVS server configuration settings for the initialization process. The port configuration for the DVS server is set, with two different ports: 1405 for an administrators port and 1410 for a clients and providers port. The database source address (e.g., an Internet Protocol address) 1415 and the domain name for the DVS server (e.g., www.mydvssite.com) 1420 are specified. The DVS server settings also include a maximum number of rooms setting 1425, a maximum number of clients in each room setting 1430, and a maximum room number setting 1435. A maximum bandwidth for each room setting 1440 is also used. The parameters are used as default settings, and can be overwritten by the administrator.

In the screen illustrated on FIG. 14, the maximum number of clients is 1000, and the maximum number of clients per room is also 1000. Thus, in this example, no logical limitation to the room exists. To limit any of the settings to “no limit”, in one embodiment, the value of −1 is entered, as it is illustrated for the bandwidth setting 1440.

Provider Connects to DVS Server

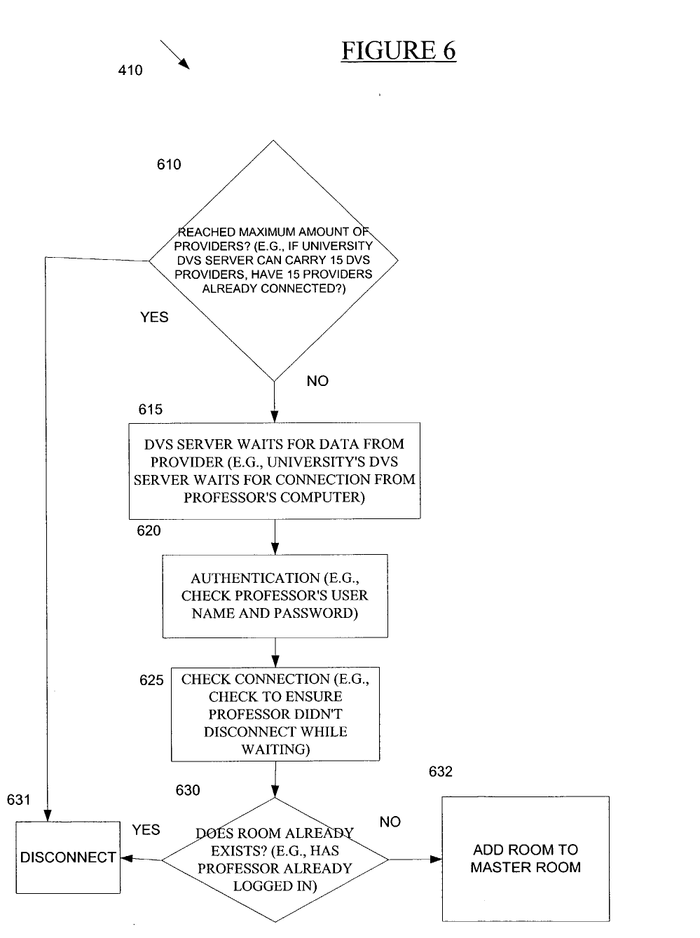

FIG. 6 is a flow diagram illustrating the provider connection to DVS server process 410, according to an embodiment of the present invention. The provider connection process has many common points with the client connection process. Both connections are authenticated and contain message loops. However, the provider connection initializes a new room, and does not join an existing room. In addition, if a room with the same name already exists, the connection is refused. A client joins a room, but a provider's room joins a master room. However, unlike the client that might attempt to join a non-existing room, the new room will never receive this error message because the master room is initialized as the service starts, and is thus active.

After the DVS server initialization process of 405, the DVS server connection sockets are waiting for connections. There are two connection types: provider connections that result in a room creation and initialization; and client connections into an existing room. FIG. 6 relates to the provider connection.

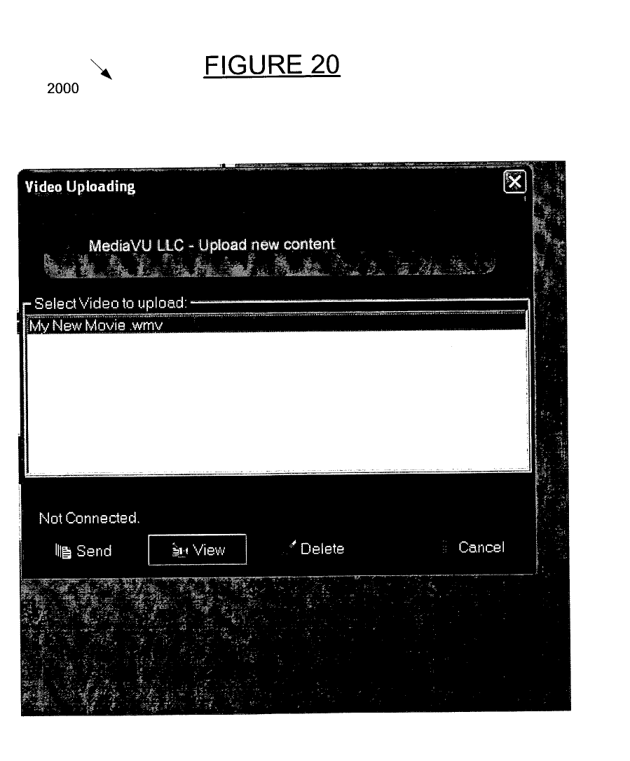

In 610, when the DVS server accepts the connection, the DVS server checks to ensure that the connection number has not reached the maximum amount (e.g., if the university DVS server can carry 15 providers, it checks to ensure there are not already 15 providers). If it has reached the maximum amount, in 631, the DVS server will return an error message, and will disconnect. If it has not reached the maximum amount, in 615, the DVS server waits for a predetermined period of time (e.g., 50 seconds) for data from the provider (e.g., the university's DVS server waits for the professor's username and password, as entered, for example in FIG. 20). If this data does not transmit in the specified time period, the connection will close at the DVS server side in order to prevent communication problems by keeping unnecessary ports opened. For the provider, the application requires the provider to enter his username and password upon connecting. In 620, the provider information is checked for authentication purposes.

In 625, the connection is continuously checked to make sure that it is open on both ends. If not, or if the DVS server fails to get response in the specified time limit, the connection is dropped on the DVS server side. (E.g., this accounts for situations where it is taking too long to log in, and the professor disconnects.)

In 630, the room requested is checked to see if it already exists. If the requested room does exist (e.g., the professor has already logged in a room), in 631 the connection is terminated. If the room does not exist, the provider's room is added to the master room in 632.

Provider Obtains Profile

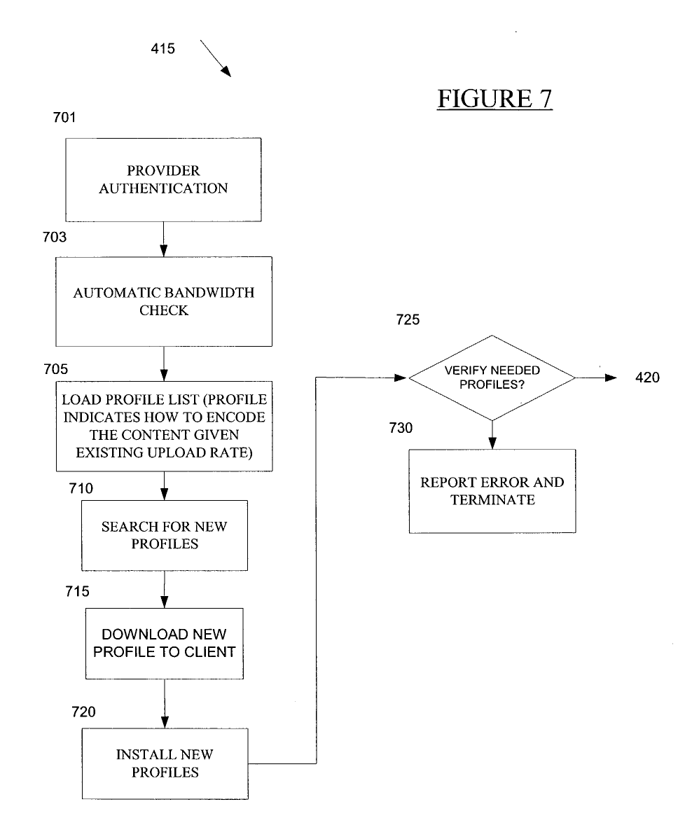

FIG. 7 is a flow diagram illustrating the provider obtaining the profile process 415, according to an embodiment of the present invention. The DVS server is responsible for getting the right profile list for a provider, making sure that the provider has the right profiles installed, and downloading new profiles if needed. In 701, the provider is authenticated. In 703, an automatic bandwidth check is completed. In 705, the results of the bandwidth check are used to find a suitable profile list to load. The profile indicates how to encode the content given the existing upload rate. In an alternative embodiment, a certain amount of bandwidth is saved to ensure that all the provider communications will pass appropriately. After the profile set is downloaded, the provider is ready for broadcasting. The provider will select the right profile for the broadcasting upon the right instructions from the DVS server.

In 710, the provider searches for new profiles. In 715, the new profile is downloaded to the clients. In 720, the new profiles are installed. In 725, it is determined if the profiles are needed. If no, in 726 an error is reported, and the program terminates. If yes, the process moves to 420.

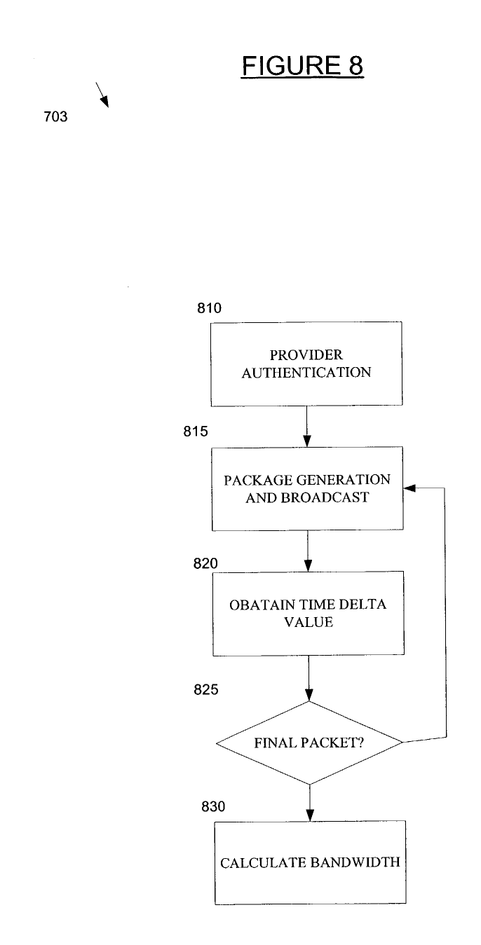

FIG. 8 is a flow diagram illustrating automatic bandwidth check process 730, according to one embodiment of the present invention. The necessity of verifying the provider bandwidth arises from the need to match a profile to an existing bandwidth, or to reject a provider request for connection upon a finding of a very low bandwidth.

In 810, the provider is authenticated. In 815, data packages are generated and broadcast to the DVS server until 1 Mb is transferred. In 820, the time delta value of the packet is determined. In 825, it is determined if the packet was the final packet. If no, the process returns to 815. If yes, in 830, the bandwidth is calculated. The data packages are checked to make sure that the data is correct. This bandwidth test is reconducted every time that the provider logs in to ensure that the result is as reliable as possible.

Establish DVS Server Connection

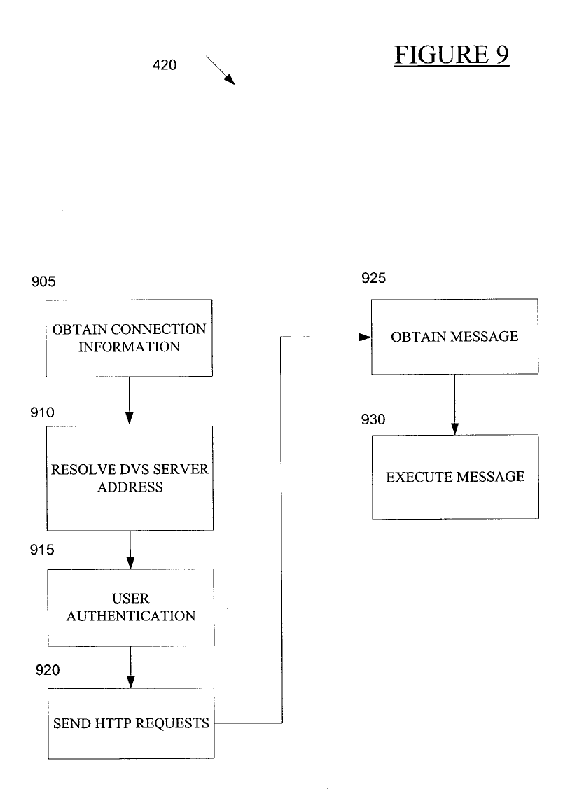

FIG. 9 is a flow diagram illustrating provider establishing DVS server connection process 420, according to an embodiment of the present invention. In 905, the provider obtains the appropriate DVS server connection information, including the connection port(s), the correct profile, and the archive option (e.g., whether to archive the encoding session into a file or not). The provider will also determine if it should also accept the DVS server connection for various purposes. If some parameters are missing, default parameters will be assigned. The defaults assigned differ according to the type of the connection manager installed.

In 910, the provider attempts to contact the server address of the DVS server. In 915, authentication takes place. If no login is required, the system provides one. In 920, the HTTP protocol sends messages to other servers (non-DVS servers) regarding the provider connection and provider updates. This connection test clears the DVS server port on the provider side. In 925, after obtaining the parameters from the DVS server (e.g., initial profile and broadcasting port), the provider initializes a listening connection on the same port as the encoder. The provider then sends a message to the DVS server, indicating success or failure in the connection. After the connection test has ended, the provider closes the listening port. In 930, the encoder engine is started.

DVS Server Publishes Provider Connection

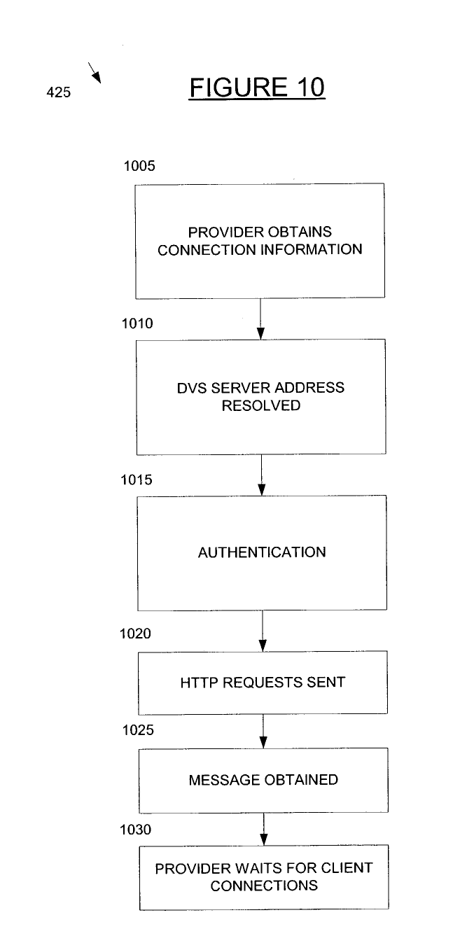

FIG. 10 is a flow diagram illustrating the DVS server publishing the provider connection process 425, according to an embodiment of the present invention. The DVS server has an internal publishing system that publishes the provider session. However, the provider may wish to send its own request to clients or other non DVS servers, which do not have a connection with the DVS server. To do this, the provider system is equipped with HTTP capabilities. The HTTP connections can be configured for HTTP servers and any port. The HTTP protocol has no limitation for the data volume, and can use both get or post commands. The HTTP connection can also be configured to send a request only when started, stopped, both, or none.

After the encoder engine is running, in 1005, the provider obtains the connection information. In 1010, the DVS server address is resolved. In 1015, authentication steps are processed. In 1020, the HTTP requests are sent. In 1025, messages are obtained. In 1030, the provider waits for client connections.

Client Connects to DVS Server

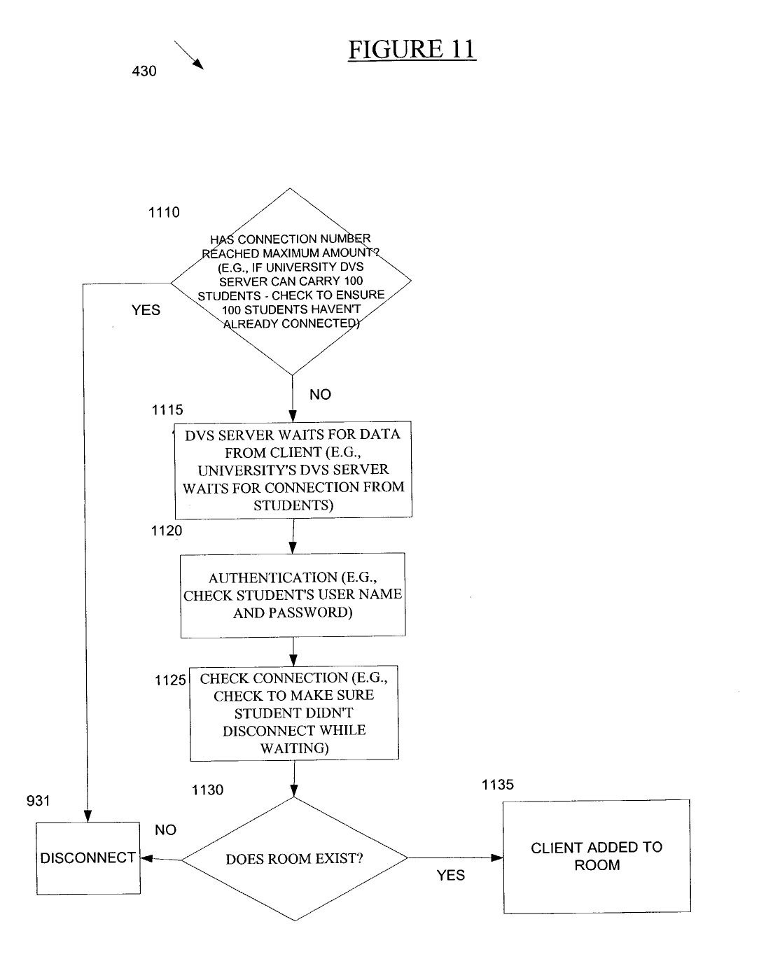

FIG. 11 is a flow diagram illustrating the client connection to DVS server process 430, according to an embodiment of the present invention. After the DVS server initialization process of 405, the DVS server connection sockets are waiting for connections. As explained above, there are two different ports settings: one for the administrator connection socket, and one for the clients and providers connection socket. There are two connection types: client connections into an existing room; and providers connections that results in a room object creation and initialization. FIG. 11 relates to the client connection.

In 1105, when the DVS server accepts the connection, the DVS server determines if the connection number has reached the maximum amount (e.g., if 100 clients are allowed, it checks to make sure 100 students have not already connected). If it has reached the maximum amount, in 1131, the DVS server will return an error message, and will close the connection. If it has not reached the maximum amount, in 1115, the DVS server waits a predetermined amount of time (e.g., 50 seconds) for data from the client (e.g., the university's DVS server waits for the student's username and password). If this data does not transmit in the specified time period, the connection will close at the DVS server side in order to prevent communication problems by keeping unnecessary ports opened. With the client, this is rarely a problem, as the client is initializing within these parameters. In 1120, the client information is checked for authentication purposes (e.g., student's user name and password are checked).

In 1125, the connection is continuously checked to make sure that it is open on both ends. If not, or if the DVS server fails to get response in the specified time limit, the connection is dropped on the DVS server side. (E.g., this accounts for situations where it is taking too long to log in, and the student disconnects.)

In 1130, the room requested is checked to see if it exists. If the requested room does not exist, in 1131 the connection is terminated. If the room does exist, the client is added to the room in 1135. The room has full control over the client connection from the point that the client connection is in the room's domain. In addition, the room also sends the necessary information messages to the other connected clients in the room, the provider and the DVS server administrator.

The room object check to see that the client is not already connected (if it is, the connection will be terminated). Any actions that need to be taken for this specific client (that is not been executed by the client's thread) are executed by allocating the client entity in the requested room. As the client “enters” the room, the connections receive the following data: the current feed path (e.g., in order to view the video feed the student's computer must provide the correct video path to the media player); the client's status (e.g., the student can be either a registered user or a guest in the system); the client's billing status, if required (e.g., if this is a pay-per-view enabled system, the student will receive a billing status, even if this specific event does not require payment); the room status (note that the room status is dependent on the provider status, e.g., if the provider is on a break, then the entire room is also in that state). The client's computer is receiving this information as well, and it can be used by the client as needed.

Execution

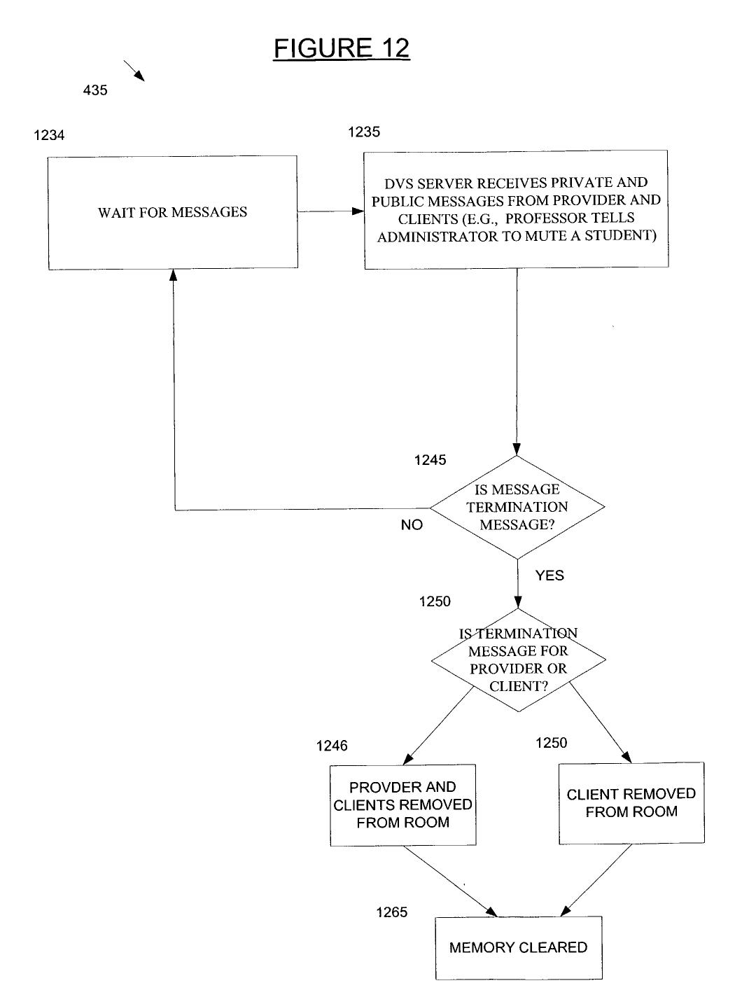

FIG. 12 is a flow diagram illustrating the execution process 435, according to an embodiment of the present invention. After the connection is public and the clients enter the session, the streaming is broadcast, and the provider manages communication with the DVS server. In 1234, the client waits for messages. The messages include: termination messages (e.g., to disembark from the socket connection); DVS server instructions (e.g., billing or administrator instructions); room instruction messages (e.g., media messages, chat messages comprising clear text messages passed from the client to the entire room, or from the provider to the room or a specific client); order messages (e.g., messages that provide the client with video capability.)

It should be noted that when a client enters a room, the client is provided with all the possible events required by the client. Chat messages are simply sent into the client as text with no special formatting, other messages are sent to the client in special formatting in order to make sure that the instructions will be executed correctly. The messages, as far as the client is concerned, are full text messages in all cases. This improves the client portability into other operating systems.

In 1234, messages arrive. A message can be a public message or a private message. In 1245, it is determined if the message is a termination message. If no, the process returns to 1234 and repeats. If yes, it is determined if the termination message is a provider or client termination message. If a provider termination message, in 1246, the provider is removed, all clients are removed, and the room is closed. If a client termination message, in 1250, the client is removed from the room. In 1265, the memory is cleared. In one embodiment, the connection may be cached so that the memory does not need to be freed, and then reallocated.

It should be noted that communication with the administrator includes at least two types of messages: chat messages and instruction messages. Chat messages are messages that are sent by the client in the room. Instruction messages are special encoded messages that contain information, for example, regarding the connection, events from the DVS server, and connection orders for the provider.

The messages are in at least two formats: pure text and enumerated. Pure text messages are messages sent as text line with proper code formatting. Enumerated messages are messages fit into predefined data packets before being sent. When received at the other end they are unpacked in a process referred to as marshalling.

Chat messages are formatted and presented. The message can be formatted in different fonts and colors. For instruction messages, the mechanism is different.

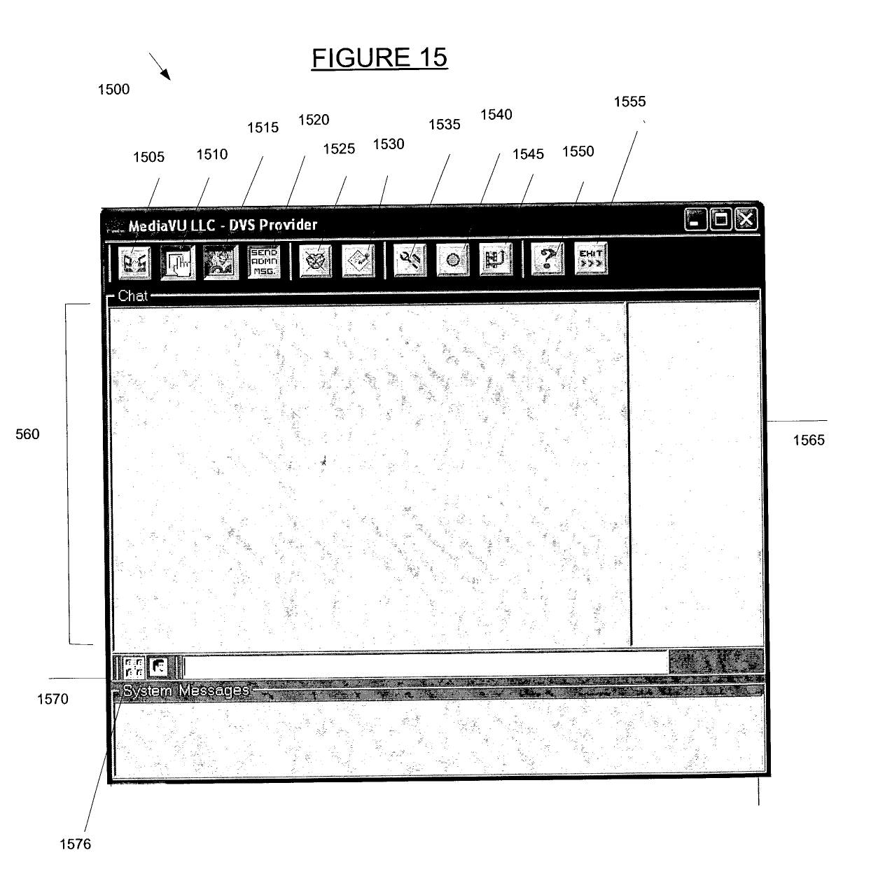

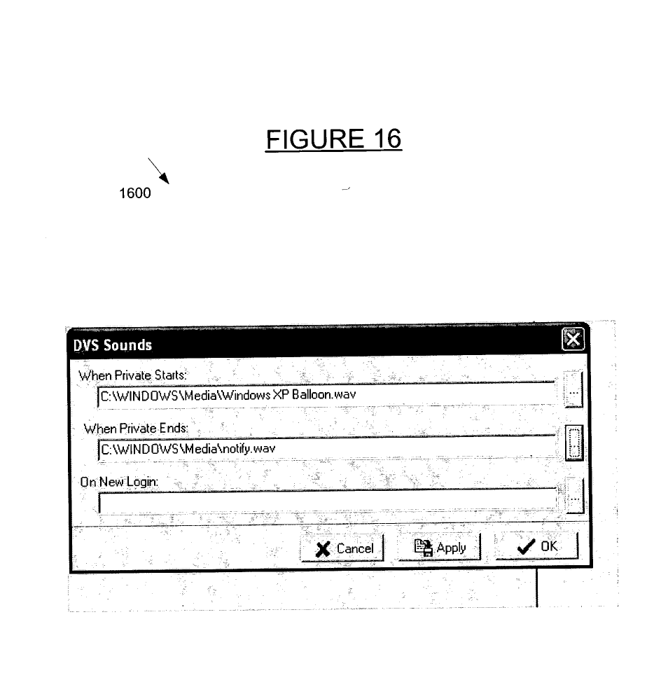

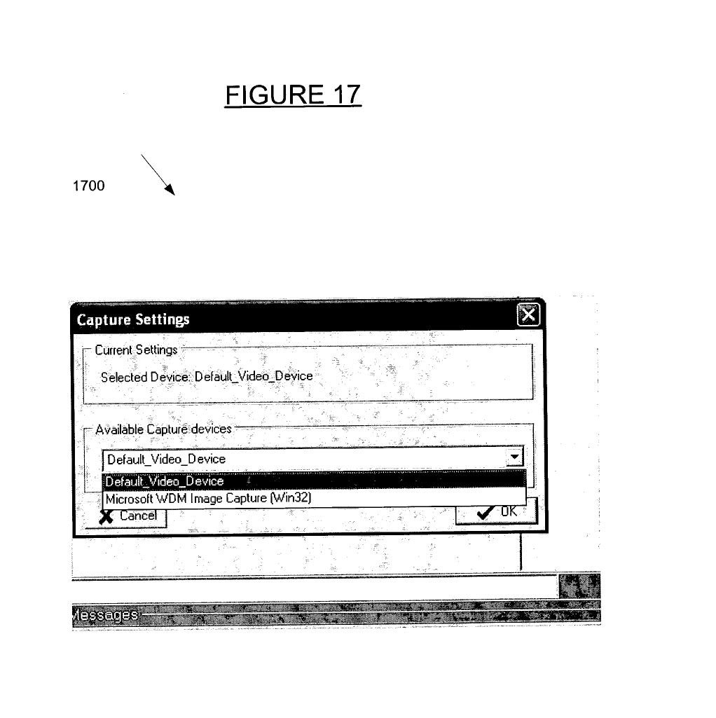

FIG. 15 is a screen shot 1500 illustrating a provider chatbox, according to an embodiment of the present invention. Connect 1505 allows the provider to log in. Stop 1510 allows the provider to stop recording or disconnect from the DVS server. Public/Private Option 1515 allows the provider to designate whether the message is public or private. Send Administrator Message 1520 allows the provider to send a message to the administrator. Kiss 1525 allows the provider to kick a client out of the room. Clear Chat Zone 1530 allows the provider to clear the chatting area. Tools 1535 allows the provider to access numerous configuration tools. These include fonts, sounds (FIG. 16), capture (FIG. 17), and device configuration settings. Record 1540 allows the provider to record content to upload. Film 1545 allows the provider to upload new content. Question 1550 allows the provider to access the help files. Exit 1555 allows the provider to exit. The User List 1565 is shown on the right side of screen 1500, and lists the providers and clients. The Chatbox 1560 is shown on the left side of screen 1500. Another Public/Private Option 1570 is illustrated. System Messages 1575 shows provider and client messages.

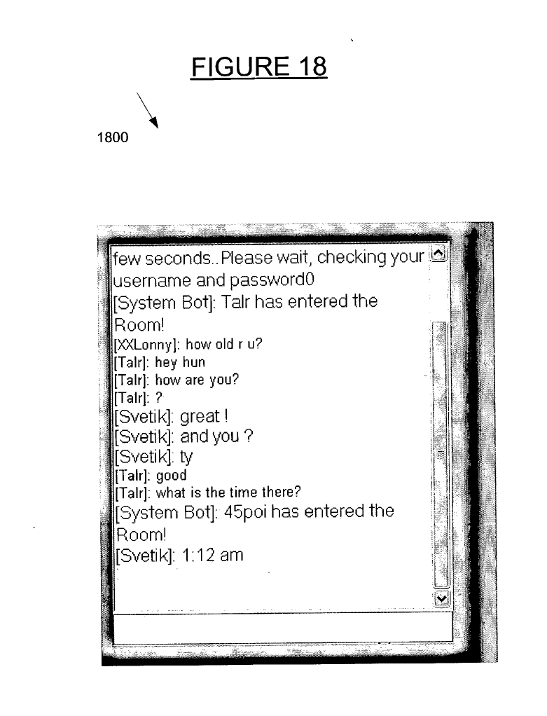

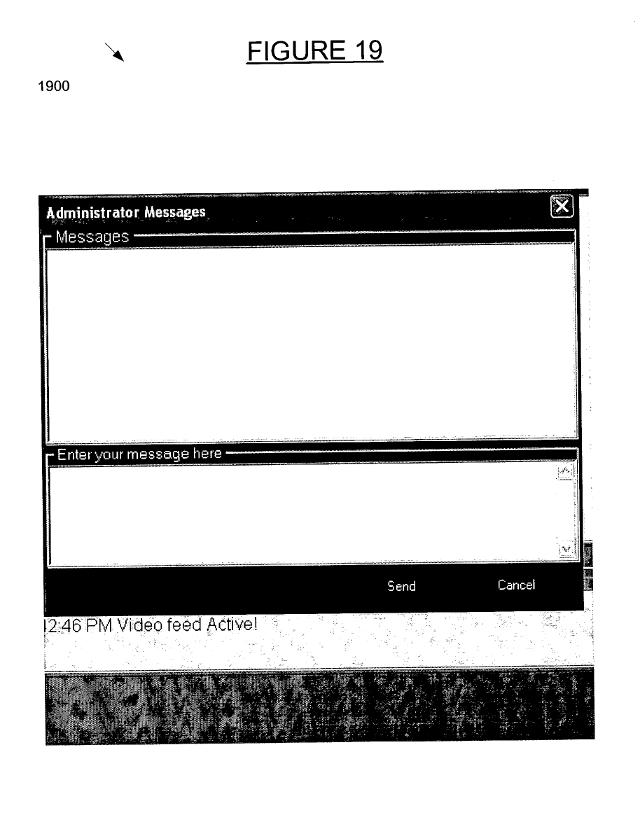

FIG. 18 is a screen shot 1800 illustrating a provider chatbox, according to an embodiment of the present invention. FIG. 19 is a screen shot 1900 illustrating an administrator message, according to an embodiment of the present invention.

Provider Upload Option

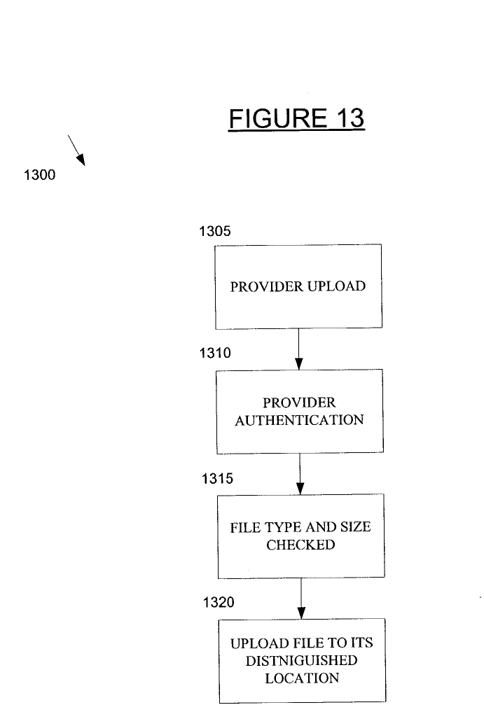

FIG. 13 is a flow diagram illustrating a provider upload option 1300, according to an embodiment of the present invention. This option enables the provider to upload more than one type of content, including a bio clip, a pay-per-view clip, and a regular recess clip. The change in the connection protocol is in the authentication process when an additional value is added in order to identify the type of content being uploaded. This option allows the DVS server administrator to reject content that is larger or smaller than certain boundaries.

This option can be applied, for example, when a professor takes a break during a broadcast class, and has a video streamed to the class during this time. The professor can also record his class session and then upload it for students to view at any time. In 1305, the provider uploads the data. In 1310, the provider is authenticated. In 1315, the file type and size are checked. In 1320, the file is uploaded to its distinguished location.

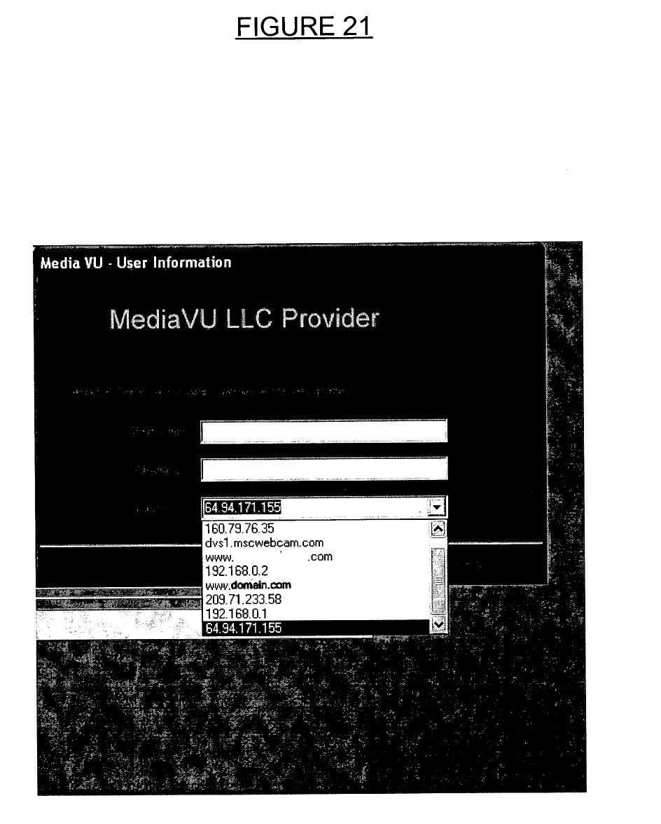

FIG. 21 is a screen shot 2100 illustrating the upload application user interface, according to an embodiment of the present invention.

Additional advantages and novel features of the invention will become more apparent to those skilled in the art or upon learning by practice of the invention.

What is claimed is:

1. A method of dynamically broadcasting content, comprising:
connecting at least one provider and at least one client to at least one server with a preset server configuration;
obtaining at least one provider run time configuration and at least one client run time configuration; and
broadcasting the content from the at least one provider to the at least one client;
whereby the at least one preset server configuration, the at least one provider run time configuration, and the at least one client run time configuration are used to connect the at least one provider and the at least one client to the at least one server without manually entering configuration information.

2. The method of claim 1, wherein the preset server configuration comprises:
a maximum room setting;
a maximum client setting;
a maximum clients per room setting;
a clients and providers port setting;
an administrators port setting;
a data base source;
a bandwidth limit setting; and
a media publishing domain setting.

3. The method of claim 1, wherein the at least one provider run time configuration comprises:
a provider Internet protocol address;
a provider broadcasting port; and
a provider bandwidth size.

4. The method of claim 1, wherein the at least one client run time configuration comprises:
a client Internet protocol address;
a client broadcasting port; and
a client bandwidth size.

5. The method of claim 1, further comprising:
broadcasting at least one message between the at least one provider and the at least one client.

6. The method of claim 1, further comprising:
broadcasting at least one message between a server administrator and at least one other user.

7. The method of claim 1, further comprising:
broadcasting billing information specific to the at least one client.

8. A method of dynamically broadcasting content, comprising:
connecting at least one provider and at least one client to at least one server;
obtaining at least one provider profile necessary to optimize at least one provider upload rate; and
broadcasting the content at an optimized upload rate.

9. The method of claim 8, wherein obtaining at least one provider profile necessary to optimize a provider upload rate comprises at least one of a group consisting of:
downloading at least one necessary profile from the at least one provider;
downloading at least one necessary profile from at least one remote location; and
downloading at least one default profile;

10. The method of claim 9, further comprising:
broadcasting at least one message between the at least one provider and the at least one client.

11. The method of claim 9, further comprising:
broadcasting at least one message between a server administrator and at least one other user.

12. The method of claim 9, further comprising:
broadcasting billing information specific to the at least one client.

13. A method of dynamically broadcasting content, comprising:
connecting at least one provider and at least one client to a first server;
obtaining at least one provider profile necessary to optimize at least one provider upload rate;
broadcasting the content at an optimized upload rate; and
automatically broadcasting a message related to the broadcast from the at least one provider to a second server.

14. The method of claim 13, wherein obtaining at least one provider profile necessary to optimize a provider upload rate comprises at least one of a group consisting of:
downloading at least one necessary profile from the at least one provider;
downloading at least one necessary profile from at least one remote location; and
downloading at least one default profile;

15. The method of claim 13, further comprising:
broadcasting at least one message between the at least one provider and the at least one client.

16. The method of claim 13, further comprising:
broadcasting at least one message between a server administrator and at least one other user.

17. The method of claim 13, further comprising:
broadcasting billing information specific to the at least one client.

18. A computer program product comprising a computer usable medium having control logic stored therein for dynamically broadcasting content, the control logic comprising:
first computer readable program means for connecting at least one provider and at least one client to at least one server with a preset server configuration;
second computer readable program means for obtaining at least one provider run time configuration and at least one client run time configuration; and
third computer readable program means for broadcasting the content from the provider to the client;
whereby the at least one preset server configuration, the at least one provider run time configuration, and the at least one client run time configuration are used to connect the at least one provider and the at least one client to the at least one server without manual system administrator involvement.

19. A computer program product comprising a computer usable medium having control logic stored therein for dynamically broadcasting content, the control logic comprising:
first computer readable program means for connecting at least one provider and at least one client to at least one server;
second computer readable program means for obtaining at least one provider profile necessary to optimize at least one provider upload rate; and
third computer readable program means for broadcasting the content at an optimized upload rate.

20. A computer program product comprising a computer usable medium having control logic stored therein for dynamically broadcasting content, the control logic comprising:
first computer readable program means for connecting at least one provider and at least one client to a first server;
second computer readable program means for obtaining at least one provider profile necessary to optimize at least one provider upload rate;
third computer readable program means for broadcasting the content at an optimized upload rate; and
fourth computer readable program means for automatically broadcasting a message related to the broadcast from the at least one provider to a second server.

21. A computerized system for dynamically broadcasting content, comprising:
a network;
at least one server coupled to the network;
at least one provider coupled to the network; and
at least one client coupled to the network;
wherein the at least one server comprises a program that enables:
connecting the at least one provider and the at least one client to the at least one server with a preset server configuration;
obtaining at least one provider run time configuration and at least one client run time configuration; and
broadcasting the content from the provider to the client;
whereby the at least one preset server configuration, the at least one provider run time configuration, and the at least one client run time configuration are used to connect the at least one provider and the at least one client to the at least one server without manual system administrator involvement.

22. A computerized system for dynamically broadcasting content, comprising:
a network;
at least one server coupled to the network;
at least one provider coupled to the network; and
at least one client coupled to the network;
wherein the at least one server comprises a program that enables:
connecting the at least one provider and the at least one client to the at least one server;
obtaining at least one provider profile necessary to optimize at least one provider upload rate; and
broadcasting the content at an optimized upload rate.

23. A computerized system for dynamically broadcasting content, comprising:
a network;
at least one server coupled to the network;
at least one provider coupled to the network; and
at least one client coupled to the network;
wherein the at least one server comprises a program that enables:
connecting the at least one provider and the at least one client to a first server;
obtaining at least one provider profile necessary to optimize at least one provider upload rate;
broadcasting the content at an optimized upload rate; and
automatically broadcasting a message related to the broadcast from the at least one provider to a second server.
